(19) United States
(12) Patent Application Publication
(10) Pub. No.: US 2008/0053260 A1
(43) Pub. Date: Mar. 6, 2008

(54) Circulation Member for Ball Screw Unit

(76) Inventors: Chi-Meng Liao, Taichung (TW); Chien-Wei Tsou, Taichung (TW)

Correspondence Address: HDSL, 4331 STEVENS BATTLE LANE, FAIRFAX, VA, 22033, US

(21) Appl. No.: 11/468,298

(22) Filed: Aug. 29, 2006

(51) Int. Cl. F16H 1/24

(52) U.S. Cl. 74/424.87

(57) ABSTRACT

A circulation member for ball screw unit includes a fixing portion, a circulation turn-off portion, and a side joint portion. The circulation turn-off portion is conjoined to the fixing portion and provided with two leading channels in connection with the female screws of the nut, wherein the other terminal of each leading channel is connected to its corresponding turn-off channel, and the side joint portion is conjoined to the circulation turn-off portion and has an auxiliary tooth shaped slot annexed to the female screws of the nut. A side turn-off channel has one end in connection with the turn-off channel of the circulation turn-off portion, while the other end thereof is in connection with an axial path of the nut, wherein the passage of the side turn-off channel is properly curved to formed a perfect ball circulation passage allowing a plurality of rolling balls to travel along smoothly.

### BACKGROUND OF THE INVENTION

1. Field of the Invention

The present invention relates to a circulation member for ball screw unit, and more particularly, to circulation member for ball screw unit being formed of a plurality of component parts to provide a side turn-off channel having a larger radius of curvature thereby allowing the rolling balls to smoothly traveling in it.

2. Description of the Prior Art

The ball screw unit is a mechanical apparatus, which is composed of a nut sleeved on a bolt so as to allow a plurality of rolling balls to travel along a helical track formed of coupling the male screws of the bolt and the female screws of the nut thereby causing a relative motion between the bolt and nut.

For enabling the rolling balls to turn around and perform invite circulation in the ball screw unit, a circulation member is provided by attaching to the female screws of the nut at the end cover where the rolling balls have to turn around.

FIGS. 1 and 2 are schematic views of a ball screw unit with a circulation member equipped on the end cover. As shown in FIGS. 1 and 2, a circulation member 10 is composed of a fixing portion 101 screwed onto the nut, an inlet terminal 102 and a turn-off terminal 103. These three component parts are combined to form the structure of a circulation path 104. To expect a perfect performance of the circulation member 10, the leading stroke of the ball screw unit should not be too short, or a thread of the helical track is scarified in order to allow the rolling balls to make a perfect truing.

In order to solve the above problem, an improvement is made wherein a tooth shaped member 201 is provided for the circulation member 20 so as to mend the aforethe broken thread portion as shown in FIGS. 3 and 4.

Incidentally, the circulation member 20 with the tooth shaped member 201 is merely combined of two sub-members 202, 203. Its length of the turn-off path is still too restricted to provide the rolling balls with a smooth and efficient moving track.

Returning to FIG. 2, Although a tooth shaped member 105 is provided for a turn-off terminal 103 of the circulation path for the purpose of compensating the broken tooth portion of the helical track in the nut, yet if the radius of curvature R formed at the turn-off terminal is too small, a smooth movement of the rolling balls, and a higher mechanical efficiency of the ball screw unit can not be anticipated. The situation is the same to either the circulation member is integrally formed or separately formed and then conjoined together.

It is what the object the inventor of the present invention has plunged into this matter for years by continuous research and experimentation in a bid of finding out the remedy to palliate the inherent shortcomings of the conventional techniques described above, and at last has succeeded in realizing the present invention.

### SUMMARY OF THE INVENTION

The present invention is to offer a circulation member of the ball screw unit a larger radius of curvature R for its circulation path, and an auxiliary tooth shaped slot so as to provide a perfect circulation passage for the rolling balls to travel along smoothly and efficiently thereby improving the mechanical effect of the ball screw unit.

The present invention provides a circulation member consisting of a fixing portion, a circulation turn-off portion, and a side joint portion. The circulation member constructed as such is affixed to the female screws of the nut. The circulation turn-off portion has a leading channel in connection with the female screws of the nut, the other side of the leading channel forms into two turn-off channels and the side joint portion is provide with the auxiliary tooth shaped slot affixed to the female screws of the nut so as to form a perfect tooth figure, and two side turn-off channels are in connection with their corresponding turn-off channels branched out of the circulation turn-off portion thereby forming a larger radius of curvature thereof, while the other end of the side turn-off channel is connected to an axial path of the nut thus completing a perfect rolling circulation passage. With this structure of circulation member consisting of the circulation turn-off portion and the side joint portion, the rolling balls are provided with a circulation path to travel smoothly and efficiently.

Another aspect of the circulation member is provided by the present invention in which the circulation turn-off portion is divided into an upper and lower members conjoined in the form of swallow tail joint. The fixing portion and the upper member of the circulation turn-off portion are integrally made in one piece whereas the side joint portion is independently formed, and the two portions are also conjoined in the form of swallowtail joint.

Still another aspect of the circulation member is provided by the present invention is divided into an upper and a lower members whereas the two members are conjoined in the form of swallow tail joint, while the fixing portion is integrally made in one piece with the upper member of the circulation turn-off portion and the side joint portion.

### BRIEF DESCRIPTION OF THE DRAWINGS

The above object and other advantages of the present invention will become more apparent by describing in detail the preferred embodiments of the present invention with reference to the attached drawings in which:

FIG. 1 is a perspective view of a nut with its circulation member in a conventional ball screw unit;

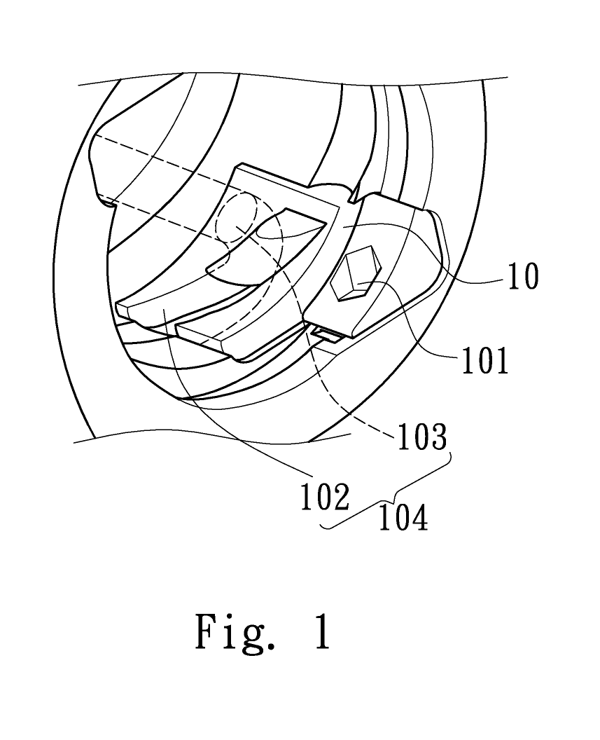

FIG. 2 is a front view of a circulation member in the ball screw unit shown in FIG. 1;

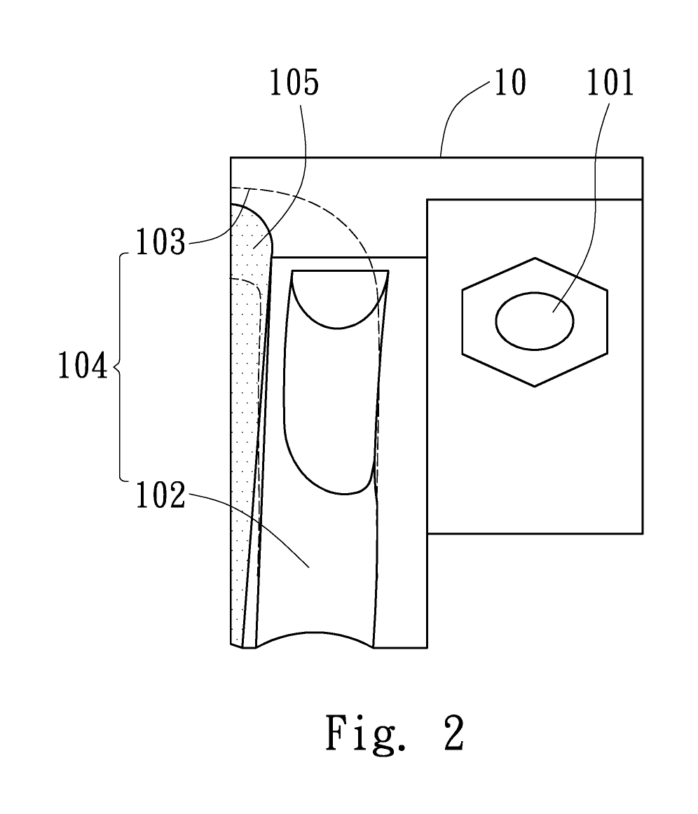

FIG. 3 is a structural schematic view of the circulation member in another conventional ball screw unit;

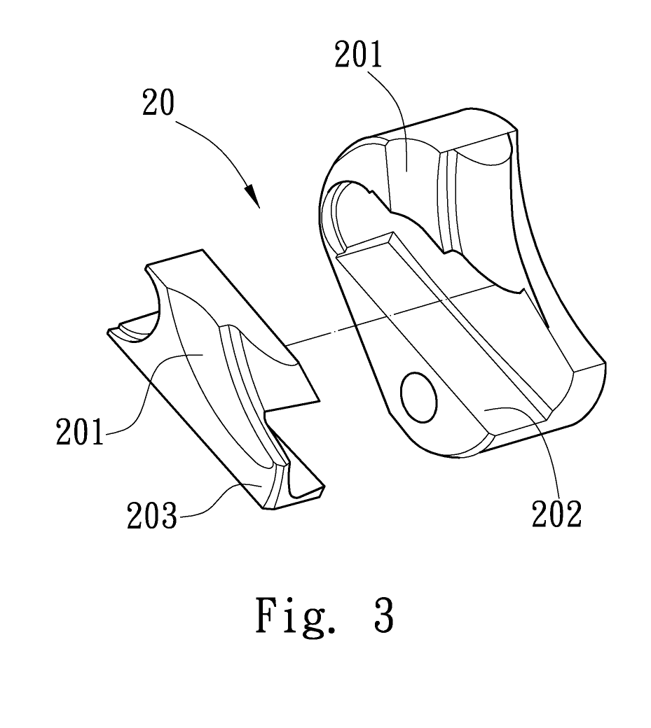

FIG. 4 is a cross sectional view of the nut with its circulation member shown in FIG. 3;

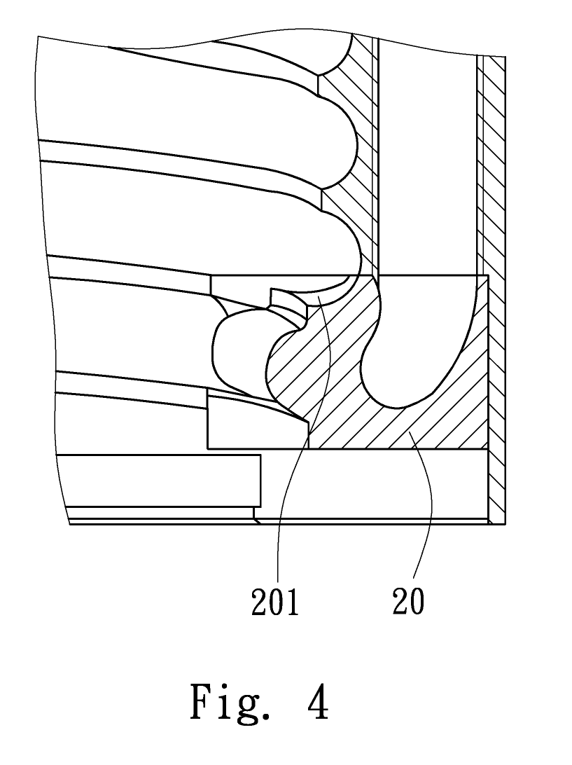

FIG. 5 is an upward view of the circulation member according to the present invention;

FIG. 6 is an exploded view of the circulation member according to the present invention;

FIG. 7 is a perspective view of the present invention;

FIG. 8 is a three dimensional illustrative view showing how to fit the circulation member to the nut according to the present invention;

FIG. 9 is a perspective assembly view of the circulation member with the nut according to the present invention;

FIG. 10 is an exploded view of the circulation member in a second embodiment;

FIG. 11 is a perspective view of the circulation member in a second embodiment;

FIG. 12 is an exploded view of the circulation member in a third embodiment;

FIG. 13 is an exploded view of the circulation member in a fourth embodiment;

FIG. 14 is an exploded view of the circulation member in a fifth embodiment; and

FIG. 15 is an exploded view of the circulation member in a sixth embodiment.

### DETAILED DESCRIPTION OF THE PREFERRED EMBODIMENT

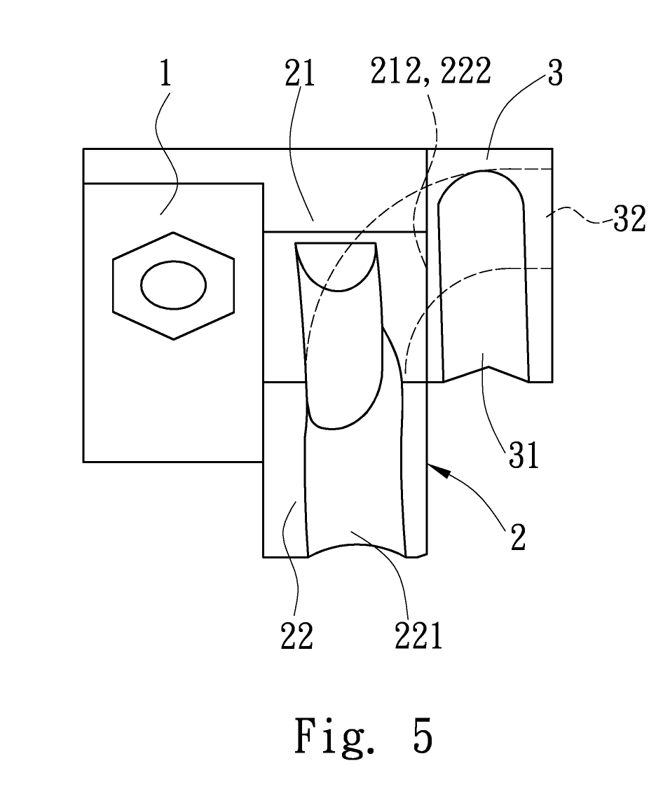

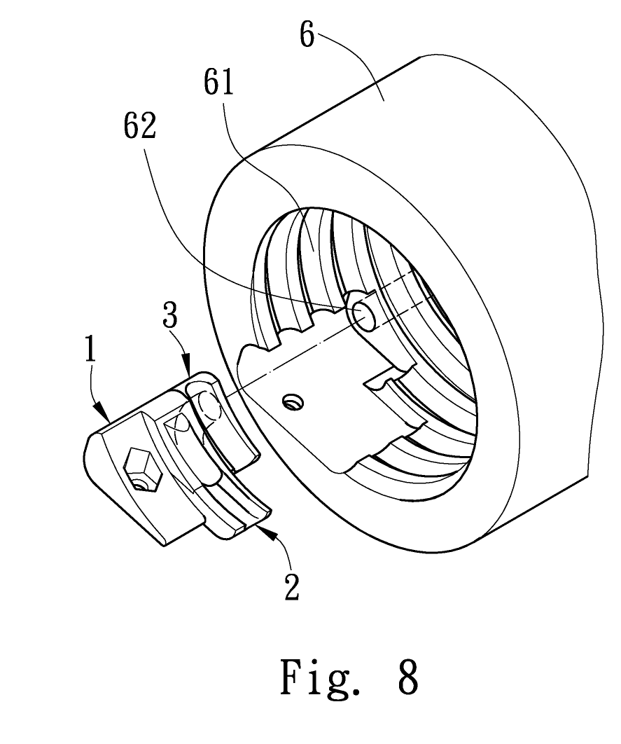

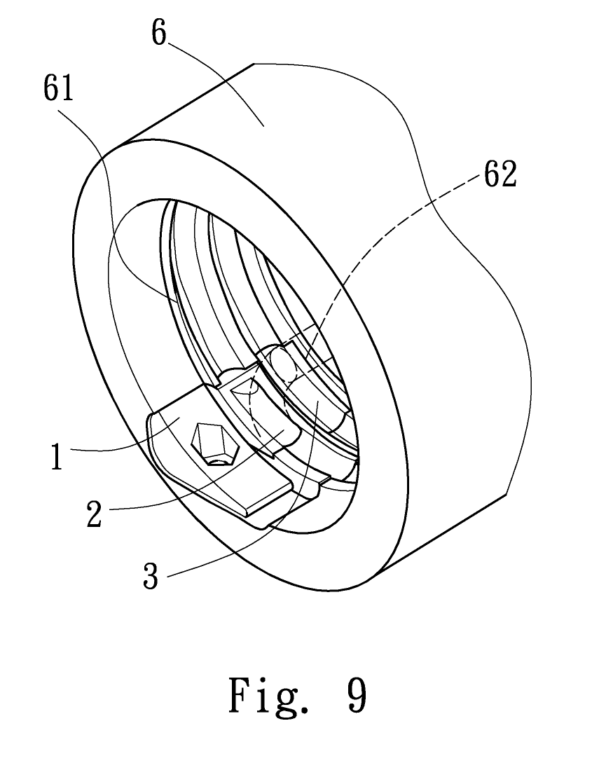

Referring to FIG. 5 through FIG. 9, the circulation member of the present invention is composed of a fixing portion 1, a circulation turn-off portion 2, and a side joint portion 3.

The fixing portion 1 is affixed to the female screws 61 of the nut 6 by screwing so as to combine with the circulation turn-off portion 2 in one piece.

The circulation turn-off portion 2 is divided into an upper member 21 and a lower member 22 which is conjoined together by tendon and mortise joint. The upper member 21 and the fixed portion 1 are integrally formed in one piece, and both upper and lower members 21 and 22 are conjoined with the side joint portion 3 by tendon and mortise joint. Two leading channels 211, 221 in connection with the female screws 61 of the nut 6 are provided for the circulation turn-off portion 2 between the upper and lower members 21 and 22. Two turn-off channels 212, 222 with a larger radius of curvature R are formed at the juncture location where the leading channels 211 and 221 are jointed to the side joint portion 3.

The independently formed side joint portion 3 is conjoined with the circulation turn-off portion 2 by tendon and mortise joint. The side joint portion 3 has an auxiliary tooth shaped slot 31 in connection with the female screws 61 of the nut 6 to mend the broken thread, and further in connection with the turn-off channels 212, 222 branched out of the circulation turn-off portion 2 so as to form a side turn-off channel 32 with a larger radius of curvature for circulation, the other terminal of the side turn-off channels 32 is connected to an axial path 62 of the nut 6 thereby forming a complete rolling circulation passage.

With such a dexterously designed circulation turn-off portion 2 and the side joint portion 3, by way of the turn-off channels 212, 222 of the circulation turn-off portion 2 to connect with the side turn-off channel 32 of the side joint portion 3, the turning curvature R of the circulation passage is enlarged thereby allowing the rolling balls to travel more smoothly in the circulation passage and improve actual mechanical effect of the ball screw unit.

Referring again to FIG. 5, here, the structure of the circulation member is not limited to the style of conjoining the fixing portion 1, circulation turn-off portion 2 and side joint portion 3 together only as described above, and instead, it can have following two different styles.

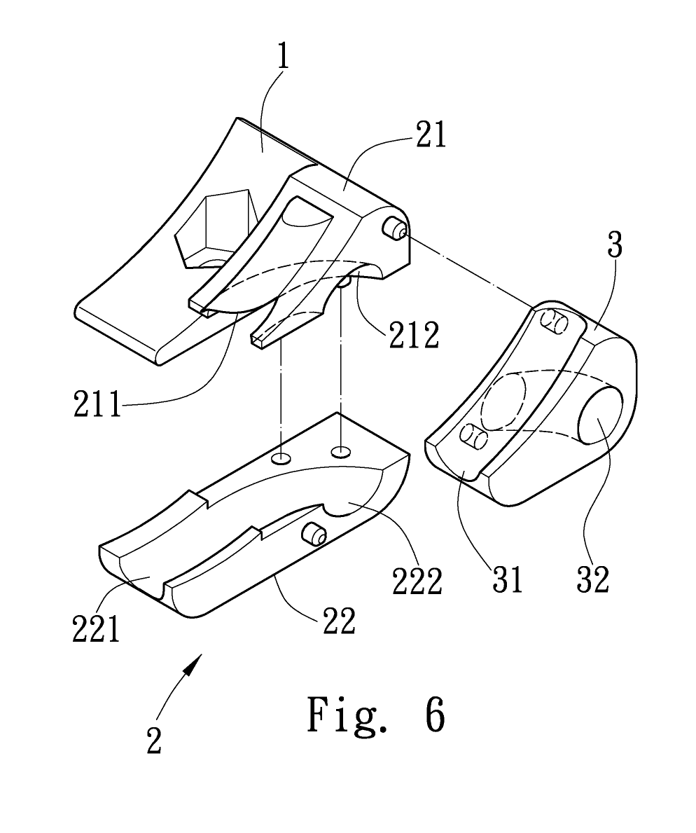

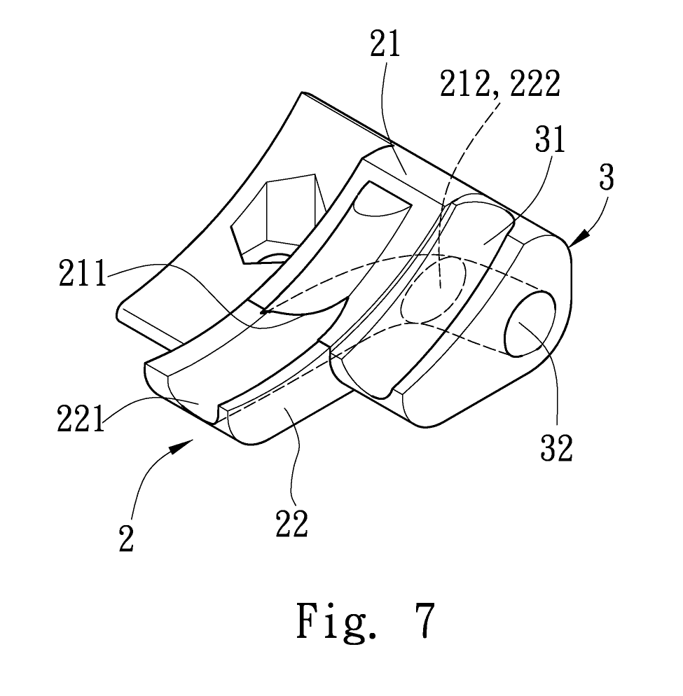

Style 1: As shown in FIGS. 6 and 7, wherein the circulation turn-off portion 2 is divided into an upper and a lower sub-members 21 and 22 conjoined to each other by tendon and mortise joint, and the side joint portion 3 is independently formed. The upper sub-member 21 of the circulation turn-off portion 2 and the fixing portion 1 is integrally formed in one piece, and the upper and the lower sub-members 21 and 22 of the circulation turn-off portion 2 are conjoined to the side joint portion 3 by tendon and mortise joint respectively.

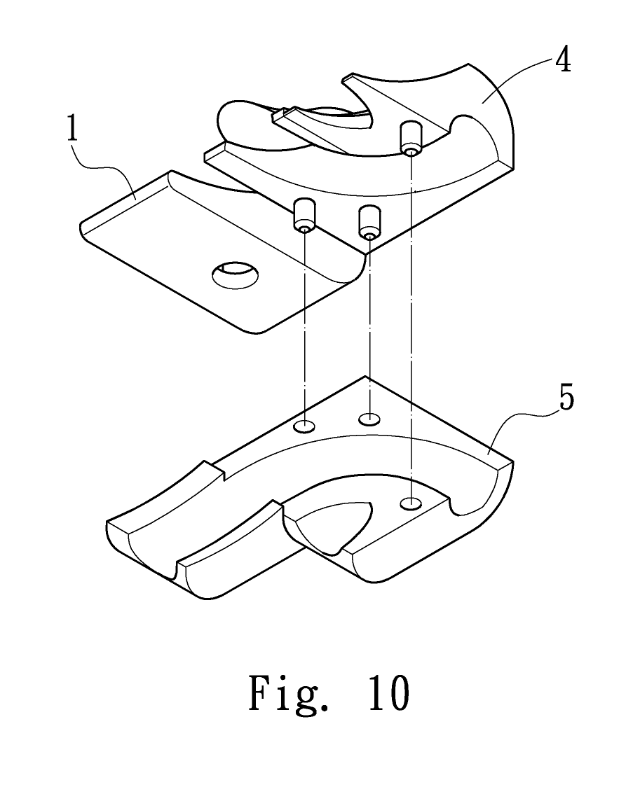

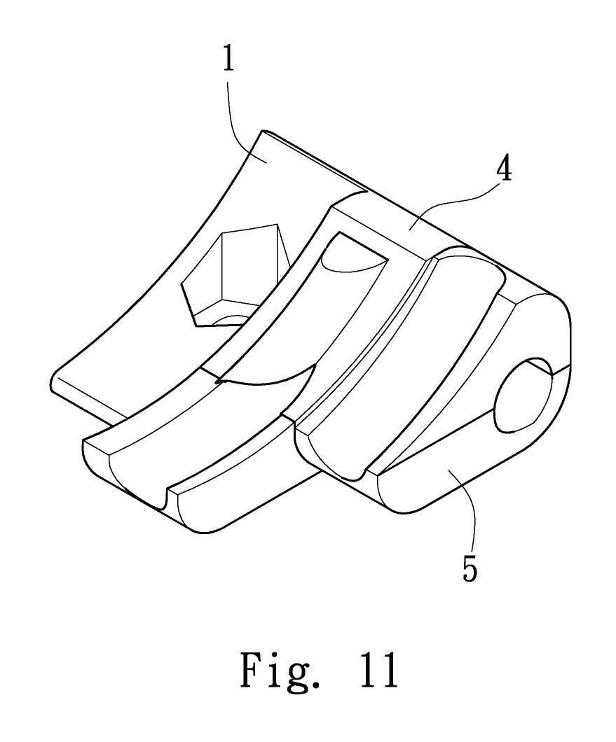

Style 2: As shown in FIGS. 10 and 11, wherein the fixing portion 1, the circulation turn-off portion 2, and the side joint portion 3 are connected in one junction piece, and the part form the circulation turn-off portion 2 to the side joint portion 3 is divided into an upper and a lower sub-members 4 and 5 conjoined to each other in the form of tendon and mortise joint.

With all above-mentioned styles, the leading channels 211 and 221, the turn-off channels 212 and 222, and the side turn-off channel 32 are provided between the circulation turn-off portion 2 and the side joint portion 3 so as to form a circulation passage allowing the rolling balls to travel smoothly and efficiently. The kernel of the structure of the circulation member provided by the present invention lies in the layout of the turn-off channels 212 and 222 with the side turn-off channel 32 extended from there so as to allow the circulation member 10 to have a larger radius of curvature R for circulation passage that facilitates the movement of the rolling balls. At the same time, an auxiliary tooth shaped slot 31 provided aft of the side turn-off channel 32 of the side joint portion 3 serves to form a perfect and smooth circulation rolling passage between the circulation member and the nut thereby practically improving the mechanical effect of the ball screw unit.

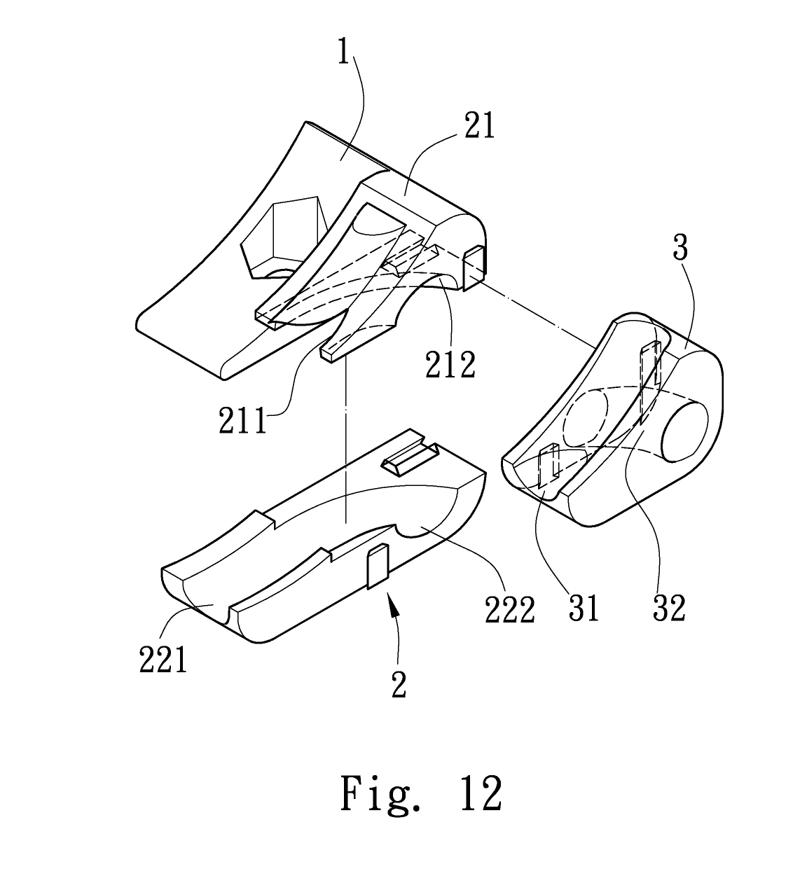

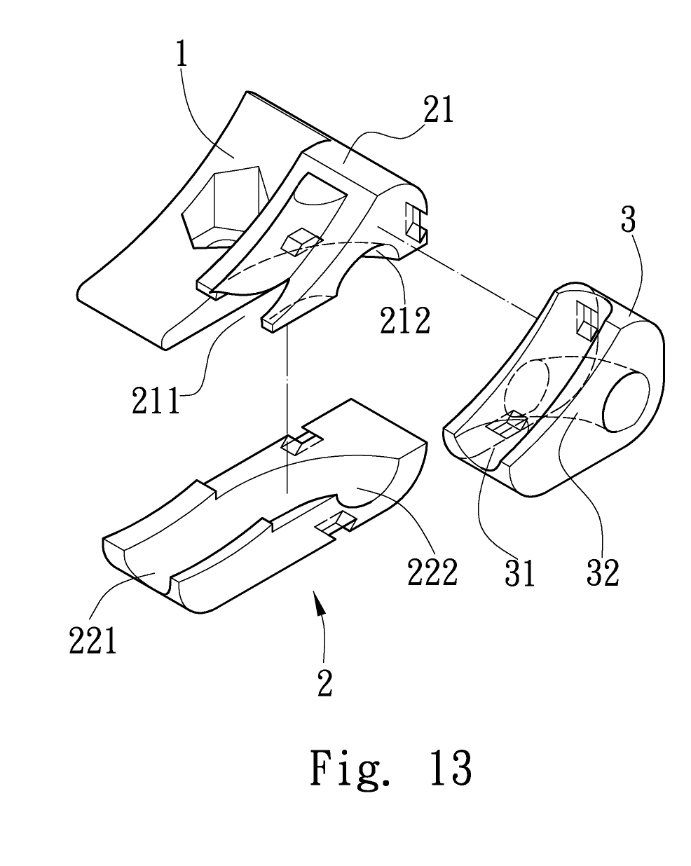

Meanwhile, as shown in FIGS. 12 and 13, in varied embodiment of the style 1, the circulation turn-off portion 2 of the circulation member is divided into an upper and a lower sub-members 21 and 22, wherein the upper one 21 is integrally formed in one piece with the fixing portion 1, and the upper and lower sub-members 21 and 22 are conjoined with each other by swallow tail joint. After conjoining together the upper and lower sub-members 21 and 22, the circulation turn-off portion 2 is then conjoined with the side joint portion 3 by swallowtail joint.

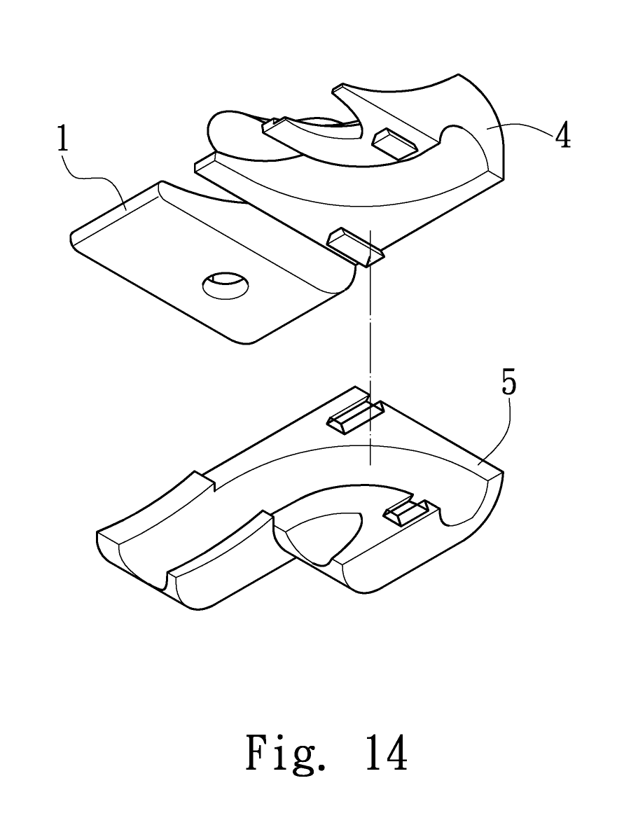

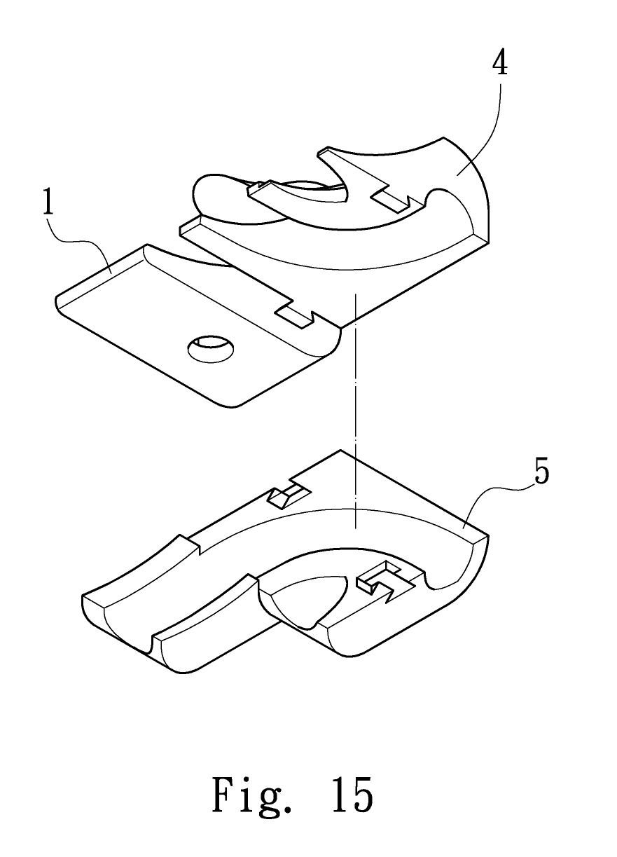

Furthermore, as shown in FIGS. 14 and 15, in a varied embodiment of the style 2, the fixing portion 1, the circulation turn-off portion 2, and the side joint portion 3 are conjoined together. The part from the circulation turn-off portion 2 to the side joint portion 3 is divided into an upper and lower sub-members 4 and 5, and the two sub-members 4 and 5 are conjoined to each other by swallow tail joint.

In brief, notwithstanding which style it belongs to (refer to FIG. 12 through FIG. 15), the appropriate swallow tail joint is employed to conjoin the fixing portion 1, the circulation turn-off portion 2, and the side joint portion 3 together reliably to provide an excellent circulation member able to contribute to the ball screw unit with effective productivity and competitiveness.

While the invention has been described in terms of what are presently considered to be the most practical and preferred embodiments, it is to be understood that the invention need not be limited to the disclosed embodiments. On the contrary, it is intended to cover various modifications similar arrangement included within the spirit and scope of the appended claims, which are to be accorded with the broadest interpretation so as to encompass all such modifications and similar structures.

What is claimed is:

1. A circulation member for ball screw unit, comprising:
a fixing portion;
a circulation turn-off portion having two turn-off channels, conjoined to the fixing portion and provided with two leading channels each with one terminal in connection with a female screw of a nut, wherein the other terminal of each leading channel is connected to a corresponding turn-off channel; and
a side joint portion conjoined to the circulation turn-off portion and having an auxiliary tooth shaped slot annexed to the female screws of the nut, and a side turn-off channel with one end in connection with the turn-off channel of the circulation turn-off portion, while the other end thereof is in connection with an axial path of the nut, wherein the passage of the side turn-off channel is properly curved to allow an plurality of rolling balls to travel along smoothly therein.

2. The circulation member of claim 1, wherein the fixing portion is positioned at the end of the female screws of the nut and integrally formed in one piece with the circulation turn-off portion.

3. The circulation member of claim 1, wherein the circulation turn-off portion is divided into an upper sub-member and a lower sub-member conjoined with each other by tendon and mortise joint, and the upper sub-member is formed integrally in one piece with the fixing portion, the upper sub-member, the lower sub-member, and the side joint portion are mutually conjoined by tendon and mortise joint.

4. The circulation member of claim 1, wherein the fixing portion, the circulation turn-off portion, and the side joint portion are conjoined integrally in one piece, wherein a part from the circulation turn-off portion to the side joint portion is divided into an upper sub-member and a lower sub-member conjoined with each other by tendon and mortise joint.

5. The circulation member of claim 1, wherein the circulation turn-off portion is divided into an upper sub-member and a lower sub-member, wherein the upper sub-member is formed integrally in one piece with the fixing portion, the upper and the lower sub-members are conjoined with each other by swallow tail joint and after conjoining the upper and the lower sub-members, the circulation turn-off portion is conjoined with the side joint portion by swallow tail joint.

6. The circulation member of claim 1, wherein the fixing portion, the circulation turn-off portion, and the joint portion are conjoined integrally in one piece, wherein a part from the circulation turn-off portion to the side joint portion is divided into an upper sub-member and a lower sub-member conjoined with each other by swallow tail joint.
